(19) United States
(12) Patent Application Publication
(10) Pub. No.: US 2013/0268420 A1
(43) Pub. Date: Oct. 10, 2013

(54) Methods and Systems for Interactive Solutioning and Visualization of Working Capital Products

(71) Applicant: CITIGROUP TECHNOLOGY, INC., New York, NY (US)

(72) Inventors: Shi Wei Ong, District 03 (SG); E May Neoh, Sheung Wan (HK); Stephen Chan, Shek Tong Tsui (HK); Keng Mun Lee, District 20 (SG); Kwan Hoon Park, District 11 (SG); Andrew Kehoe, Midlevels (HK); Alfonso Martin, Pokfulam (HK); Anthony Nappi, Shouson Hill (HK); Geraldine Yip, Wanchai (HK); Dianne Challenor, Midlevels (HK); Sudeep Yadav, Mumbai (IN); Gourang Shah, District 15 (SG); Philippe Jaccard, Happy Valley (HK); Jason Batman, District 15 (SG); Mike David, Midlevels West (HK); Danielle Johnson, District 19 (SG); Peter Williams, Midlevels (HK); Elizabeth Towler, New York, NY (US); Gary Greenwald, Bedford Hills, NY (US); Yogesh Ajinkya, Mumbai (IN); Sabiha Kazi, Mumbai (IN)

(73) Assignee: Citigroup Technology, Inc., New York, NY (US)

(21) Appl. No.: 13/857,285

(22) Filed: Apr. 5, 2013

Related U.S. Application Data
(60) Provisional application No. 61/620,542, filed on Apr. 5, 2012.

(51) Int. Cl. G06Q 40/02

(52) U.S. Cl. CPC G06Q 40/02
USPC 705/35

(57) ABSTRACT

Methods and systems for real-time, interactive solutioning and visualization of working capital for an enterprise employ a processor coupled to memory and other computer hardware and software components for storing fixed data consisting at least in part of information regarding financial institution products and information regarding governmental regulations; storing variable data consisting at least in part of information regarding operations of the enterprise; receiving variable data interactively consisting at least in part of information regarding enterprise preferences; and generating at least one recommendation for a proposed structure for the enterprise based at least in part on the fixed data and the variable data.

### PRIORITY APPLICATION

This application claims the benefit of U.S. Provisional Application No. 61/620,542 filed Apr. 5, 2012 entitled “METHODS AND SYSTEMS FOR INTERACTIVE SOLUTIONING AND VISUALIZATION OF WORKING CAPITAL PRODUCTS” and incorporated herein by this reference.

### FIELD OF THE INVENTION

The present invention relates generally to the field of financial services and more particularly to methods and systems for providing financial services solutions and interactive visualization using computer hardware and software.

### BACKGROUND OF THE INVENTION

Currently, in a typical business environment, such as a banking environment, a business, such as a global financial institution, usually interacts with its clients by following various steps, such as consulting and learning the client's needs, and proposing potential solutions to the client. During this process, visual aids and supporting materials, such as numerous POWERPOINT® slides and EXCEL® sheets, may typically be employed by the financial institution. If the financial institution goes to a client and makes a presentation, the client may give the financial institution feedback. The financial institution may in turn go back and update the proposed solutions, which may typically include changes to the POWERPOINT® slides and EXCEL® sheets. The financial institution may then return to the client and receive more feedback. This iterative process may typically go on for weeks or months before an agreement is reached between the financial institution and its client on a particular proposal. This is only the first stage of the client engagement cycle for the financial institution, which will typically be followed by preparation of implementation plans and legal documentations, execution of the actual implementation process, and maintenance of the implemented solution for the client.

There is a need for a real-time interactive tool that empowers businesses, such as global financial institutions, with instantaneous, interactive solutioning and visualization of working capital capabilities for enterprises.

### SUMMARY OF THE INVENTION

Embodiments of the invention employ computer hardware and software, including, without limitation, one or more processors coupled to memory and non-transitory computer-readable storage media with one or more executable programs stored thereon which instruct the processors to perform the methods and systems for embodiments of the invention described herein.

Embodiments of the invention provide methods and systems for real-time, interactive solutioning and visualization of working capital for an enterprise that may involve, for example, storing, using a processor coupled to memory, fixed data consisting at least in part of information regarding financial institution products and information regarding governmental regulations; storing, using the processor, variable data consisting at least in part of information regarding operations of the enterprise; receiving, using the processor, variable data interactively consisting at least in part of information regarding enterprise preferences; and generating, using the processor, at least one recommendation for a proposed structure for the enterprise based at least in part on the fixed data and the variable data.

In aspects of embodiments of the invention, storing the information regarding governmental regulations may involve, for example, storing information regarding governmental regulations related to liquidity management. In other aspects, storing the information regarding governmental regulations related to liquidity management may involve, for example, storing a regulatory grid of information regarding governmental regulations related to liquidity management in a plurality of different countries. In further aspects, storing the information regarding financial institution products may involve, for example, storing information regarding an availability of financial institution products in a plurality of different countries in a plurality of different currencies.

In other aspects of embodiments of the invention, storing the information regarding the availability of financial institution products in the plurality of different countries may involve, for example, storing a capability grid of information regarding the availability of financial institution products in the plurality of different countries in the plurality of different currencies. In further aspects, storing the information regarding operations of the enterprise may involve, for example, storing enterprise information consisting at least in part of operating balances, legal entities, and geographic locations of the enterprise. In additional aspects, storing the variable data may involve, for example, storing anonymized information regarding operations of at least one other enterprise. In still further aspects, storing the anonymized information may involve, for example, storing anonymized information regarding operations of at least one peer of the enterprise.

In further aspects of embodiments of the invention, receiving the variable data interactively may involve, for example, processing the received variable data with the stored fixed data and stored variable data using decision tree logic. In other aspects, receiving the variable data interactively may involve, for example, receiving at least one change in the received variable data and processing the at least one received change in the received variable data with the stored fixed data and stored variable data using separate decision tree logic. In still other aspects, receiving the variable data interactively may involve, for example, receiving the variable data interactively via answers to questions displayed on a terminal. In additional aspects, receiving the variable data interactively may involve, for example, receiving the variable data interactively via answers to questions displayed on the terminal by one of a liquidity management module, a payments and receivables module, a supply chain module, and a benchmarking module. In still further aspects, receiving the variable data interactively via answers to questions displayed on the terminal may involve, for example, displaying a geographic visualization of the enterprise's global operations based at least on part on the stored variable data.

In additional aspects of embodiments of the invention displaying the geographic visualization of the enterprise's global operations may involve, for example, displaying a drilled down geographic visualization of the enterprise's operations in at least one geographic region. In other aspects, displaying the geographic visualization of the enterprise's global operations in at least one geographic region may involve, for example, displaying a drilled down geographic visualization of the enterprise's operations in at least one country. In further aspects, displaying the geographic visualization of the enterprise's global operations may involve, for example, displaying the geographic visualization of the enterprise's global operations by a liquidity management module. In still further aspects, displaying the geographic visualization of the enterprise's global operations by the liquidity management module may involve, for example, displaying indicia of geographic locations of the enterprise's operations. In still other aspects, displaying the geographic visualization of the enterprise's global operations by the liquidity management module may involve, for example, displaying financial information in association with the indicia of geographic locations of the enterprise's operations.

In other aspects of embodiments of the invention, generating the at least one recommendation may involve, for example, generating the at least one recommendation for the proposed structure for the enterprise using decision tree logic of an interactive module. In additional aspects, generating the at least one recommendation may involve, for example, generating the at least one recommendation using the decision tree logic in a step-by-step validation of the received variable data and the stored variable data in a plurality of combinations and permutations against the stored fixed data. In further aspects, generating the at least one recommendation may involve, for example, populating at least one implementation plan and at least one legal document for the proposed structure. In still further aspects, generating the at least one recommendation may involve, for example, digitally executing the at least one legal document for the proposed structure.

These and other aspects of the invention will be set forth in part in the description which follows and in part will become more apparent to those skilled in the art upon examination of the following or may be learned from practice of the invention. It is intended that all such aspects are to be included within this description, are to be within the scope of the present invention, and are to be protected by the accompanying claims.

### BRIEF DESCRIPTION OF THE DRAWINGS

FIG. 1 is a table that illustrates examples of core modules and supporting modules for embodiments of the invention;

FIG. 2 is schematic diagram which illustrates an example of front end and back end components for embodiments of the invention;

FIG. 3 shows an example client landing page for a liquidity management module for embodiments of the invention;

FIG. 4 shows an example of a geographic drill-down page for the liquidity module for embodiments of the invention;

FIG. 5 is a table which illustrates examples of functions employed in a liquidity management aspect for embodiments of the invention; and

FIG. 6 is a flow chart that shows an example of a process of interactive solutioning and visualization for embodiments of the invention.

### DETAILED DESCRIPTION

Each example herein is provided by way of explanation of the invention, not as a limitation of the invention. It will be apparent to those skilled in the art that various modifications and variations can be made in the present invention without departing from the scope or spirit of the invention. For example, features illustrated or described as part of one embodiment can be used in another embodiment to yield a still further embodiment. Thus, it is intended that the present invention cover such modifications and variations that come within the scope of the invention.

The real-time, interactive solutioning and marketing tool for embodiments of the invention transforms the way in which a business, such as a global financial institution, engages with clients. For example, embodiments of the invention may streamline several weeks' work of solutioning processes into one afternoon's session with the clients, guiding them through the complexities of their operating environment and assisting them to make informed decisions. Embodiments of the invention provide an instantaneous solutioning capability based on decision tree algorithms and user-friendly interactive graphics to enable clients to visualize a customized working capital story. Further, benchmarking capabilities of embodiments of the invention may allow clients to compare their treasury health against peers in the market. Thus, embodiments of the invention complement the financial institution ‘global transaction services professionals’ experience and expertise to deliver optimal working capital solutions for its clients.

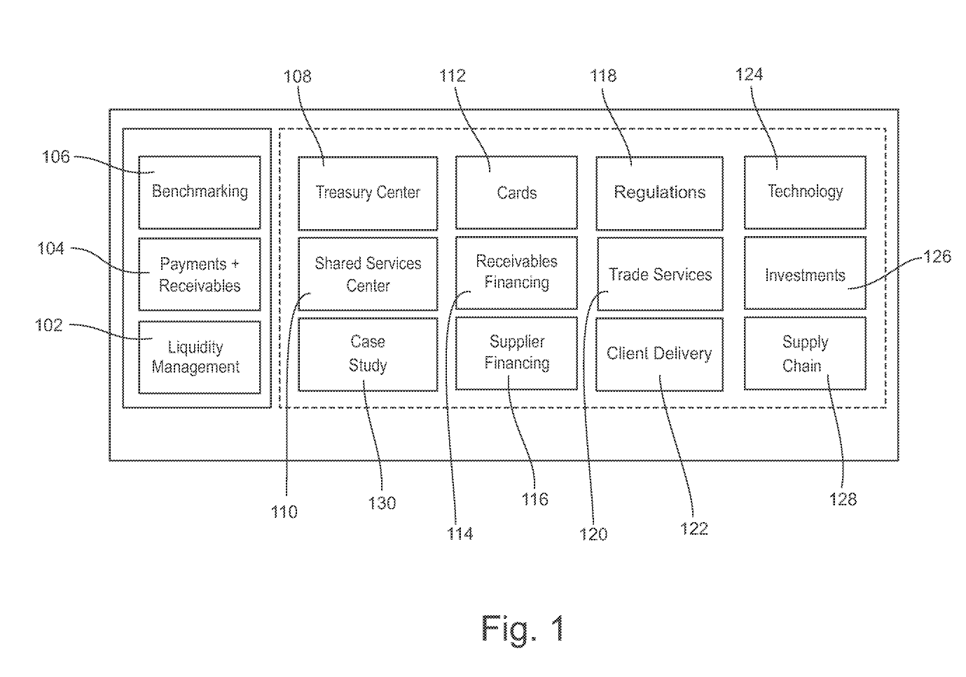

Aspects of embodiments of the invention include a number of core solutioning modules, as well as a number of supporting modules. FIG. 1 is a table that illustrates examples of core and supporting modules for embodiments of the invention. Referring to FIG. 1, core modules may include, for example, a liquidity management module 102, a payments and receivables module 104, and a benchmarking module 106, which are integrated with various supporting modules. Referring further to FIG. 1, supporting modules for embodiments of the invention include, for example, treasury 108, shared services 110, cards 112, receivables financing 114, supplier financing 116, regulations 118, trade services 120, client delivery 122, technology 124, and investments 126 modules. In embodiments of the invention, some or all of such core products are integrated into a holistic marketing solutioning tool that generates a complete working capital solutioning story for clients of the financial institution. The real-time, interactive solutioning and marketing tool for embodiments of the invention fully automates and synchronizes the end-to-end client engagement process. Such end-to-end process extends from an initial pitch to a client employing interactive solutioning to the delivery and maintenance of an agreed solution for the client in which implementation plans and legal documents are automatically populated. Moreover, such plans and legal documents are digitally signed and securely stored in an electronic vault.

Aspects of the interactive solutioning methods and systems for embodiments of the invention provide real-time customized working capital solutions based on a client's goals, priorities, and preferences by running decision tree based algorithms. Other aspects aid clients in visualizing the benefits of the global coverage and capabilities of the global financial institution. Additional aspects enable live physical interaction through media walls and tablet PCs, achieving content delivery and communication in a way that is non-traditional and innovative. Further aspects reduce data analysis time and expedite the decision-making process by all stakeholders, including clients, sales teams, and solution managers, to enhance the overall solutioning experience. As previously noted, in a present-day business environment, client engagement typically begins with preparation and presentation of a presentation book made of static POWERPOINT® slides with manual EXCEL®-based analysis. When a client requests alterations of a proposed solution, the sales team brings the client's feedback to solution managers for further analysis. Such an iterative client engagement process may take twenty to seventy days or more to reach an agreed solution and often dilutes the overall client experience due to delay and loss in translation.

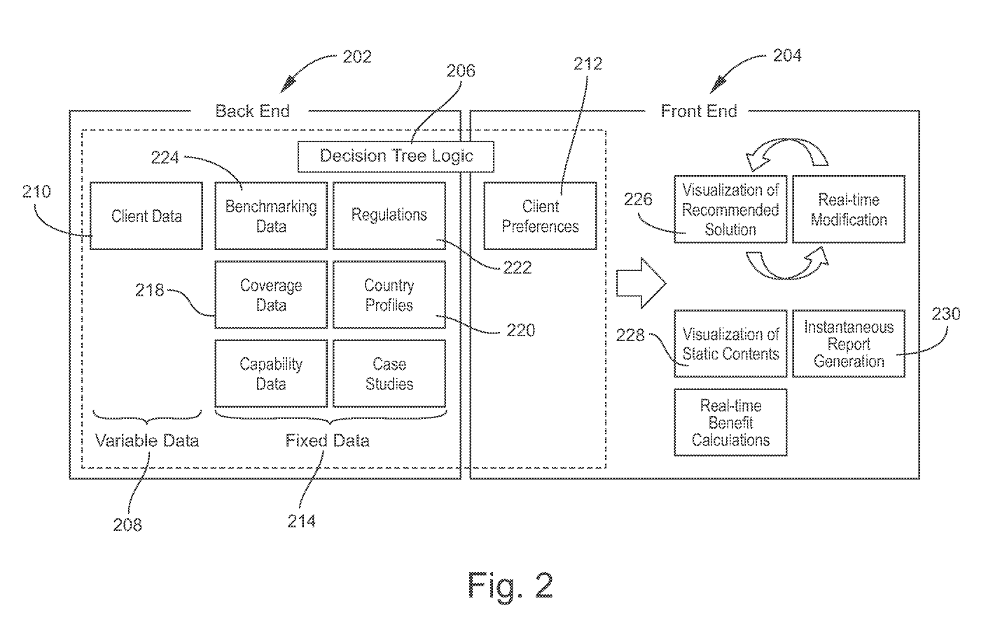

The liquidity management module 102 of embodiments of the invention reduces the current lengthy data analysis process, which may currently take twenty to seventy days, to a real-time process. Interactive solutioning for embodiments of the invention may be divided into two aspects, a back end aspect 202 and a front-end aspect 204, an example of which is illustrated in FIG. 2. A main objective of the back end aspect 202 may be to store and process data through decision tree logic 206. The back end aspect 202 may include variable data 208, such as client data 210. Client data 210 for the back end aspect 202 may include information relating to a client, such as operating balances, legal entities, and locations. Such client data 210 may be entered, for example, via a front end interface which may form a set of variables that may be processed via decision tree logic 206 to display results. Fixed data 214 for the back end aspect 202 may include various data sets, such as financial institution product capabilities 216, coverage 218, country profiles 220, regulations and tax information 222, and benchmarking data 224, which may be used for validation against decision tree logic or filtering and processing for visual presentation on the front end 204. The decision tree logic 206 for the back end aspect 202 may provide a logical approach to the way in which data may be sorted and applied to a list of decision trees which results in respective solutions based on a client's preferences 212 as expressed in response to preference questions. This process is dynamic since the client may choose to change answers to the preference questions, whereupon the system validates and triggers a separate decision tree.

An objective of the front end aspect 204 captures a client's inputs and presents the results. Client preferences 212 and other inputs may be captured on the front end 204 using, for example, a list of questions. Client preferences 212 serve as a first step towards the solutioning process. Client preferences 212 may be considered to be variable data 208 since different combinations of responses may result in an application of different decision trees. Client preferences 212 and other inputs are captured on the front end 204 via touch functionality of a display which is intuitive for easy usage by users. A visualization aspect 226, 228 of results using graphics may likewise be intuitive for users. The visualization aspect 226, 228 may engage users and illustrate to users a manner in which a solution may be delivered to a client. In a reports aspect 230, reports are generated instantaneously and provided, for example, by email directly to clients via the real-time, interactive solutioning and marketing tool.

Aspects of the interactive solutions for embodiments of the invention include, for example, various modules such as the liquidity management module 102 as shown in FIG. 1. Liquidity management enables a global financial institution to assist its clients to better manage the clients' cash and to enable the clients to better utilize their operating cash to run their daily business activities. The liquidity management module 102 requires users to gather a certain amount of client data, such as account balances, and the specific characteristics of such balances such as resident status, ownership, account type, currency, and similar data. In addition, embodiments of the invention employ fixed data 214 as shown in FIG. 2, such as regulatory 222 and capability 216 data. Such fixed date 214 may include, for example, all the regulations 222 in the market that are related to liquidity management. Such fixed data 214 may also include, for example, the financial institution's product capability 216, such as the types of products that the financial institution may provide its clients in different countries and regions throughout the world. In embodiments of the invention, using these data points as a basis, the financial institution may receive input from a client in terms, for example, of client preferences 212. The financial institution may ask the client a number of questions. Based on a combination of the questions and the client's answers to those questions and using the foregoing data sets as a background, the liquidity management module 102 may use various algorithms to automate the process of determining a proposed structure for the client presented as a visualization of a recommended solution 226.

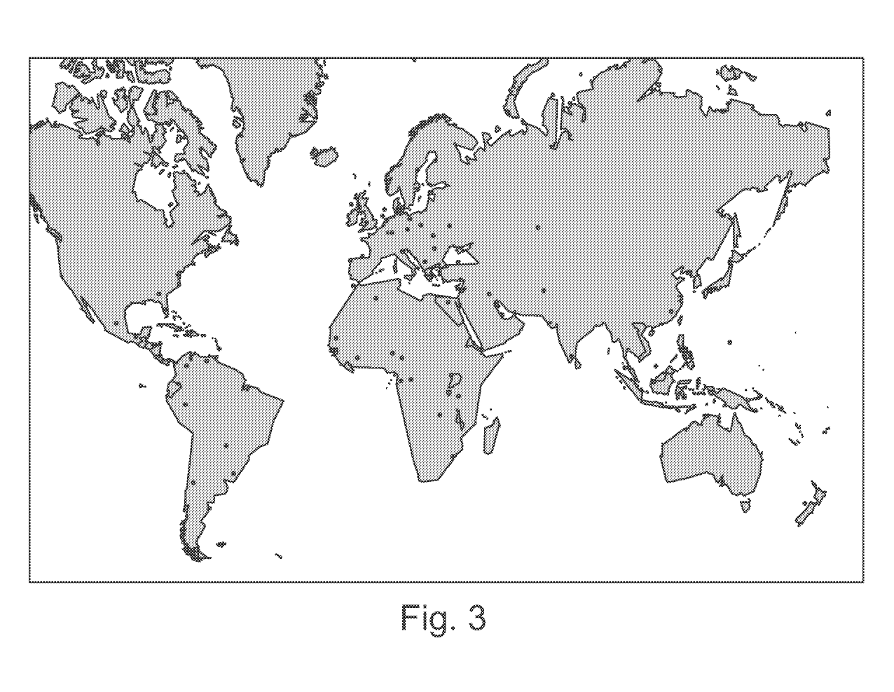

In the liquidity management aspect 102, a user may log on the application for embodiments of the invention and be presented with a landing or starting page for the interactive solutions. The user clicks on a “liquidity management” selection displayed on the starting page by the application. When the user selects “liquidity management”, a client landing page is displayed by the application which consists of a map of all or a portion of the world with dots at various locations around the world, an example of which is shown in FIG. 3. The dots shown on the landing page illustrate a summary view of locations of a particular client worldwide. For example, alphanumerical text associated with the dots may be displayed to represent operating balances for a particular client globally. Further, the dots may be displayed in particular colors, such as yellow, to represent locations of the global financial institution. The dots may be displayed, for example, with halos to represent locations where the global financial institution and the client are both present.

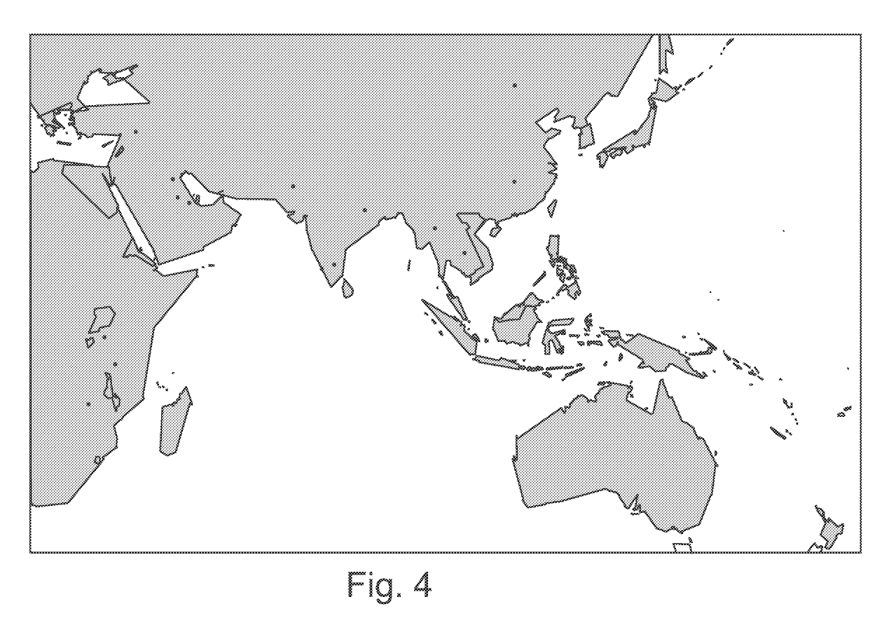

In embodiments of the invention, the client is allowed to drill down, for example, to display a particular geographic area, such as the Asia Pacific region, an example of which is shown in FIG. 4. The dots shown on the drill-down page may likewise represent locations of the client in the particular geographic area. The dots may be displayed with a halo of a particular color, such as a red halo, to represent regulated countries in the region, for example, in which the global financial institution may not be allowed to freely move cash. The dots may be displayed with halos of a different color, such as blue halos, to represent the least-regulated countries, where the global financial institution may have more freedom to transfer funds. The dots may be displayed with halos of still another color, such as gray halos, to represent semi-regulated countries in which at least some restrictions are imposed on the financial institution.

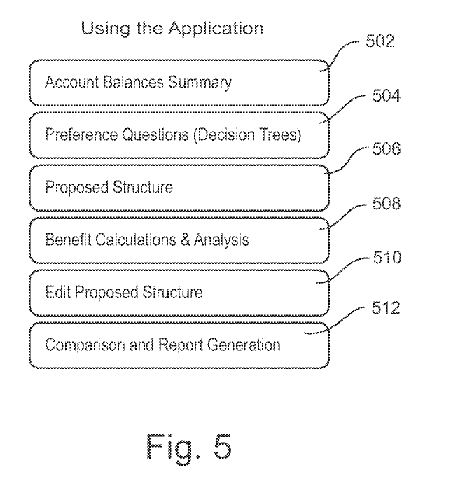

FIG. 5 is a table which illustrates examples of the functions employed in the liquidity management module 102 for embodiments of the invention. Such functions may include, for example, account balances summary 502, preference questions and decision tree analysis 504, proposed structure 506, benefit calculations and analysis 508, proposed structure editing 510, and comparison and report generation 512. The data points for client locations and related client information displayed on the summary view and the drill down page are all input using data collected in advance from clients of the financial institution, such as account balances 502, and uploaded to the system for embodiments of the invention. Using the client data at hand, specific questions 504 may be presented to a particular client by the system for embodiments of the invention that are related to the issue of a liquidity structure for the client. For example, the client may be prompted to answer questions 504 such as the client's main objective or the client's preferred liquidity structure. For another example, the client may be prompted with a question about the client's preferred regional concentration location. If the client selects a particular country, the client may be asked about inter-company loans.

After the client has answered various questions, embodiments of the invention may employ decision tree algorithms on the backend to validate various products which the financial institution may offer to the client in different locations around the world against all the databases of regulations and capabilities. Based on such validation and the decision trees that are employed, a solution may be produced which translates into a structure 506 in which all of the client's cash may be seen, for example, moving into a concentration center. In other words, such a solution may involve sweeping all of the client's cash into one location, which may allow the client to better manage its operating balances required to run its daily business. Further, the decision tree algorithm may cater for country specific nuances. For example, in a particular country, entrust loan and tax related issues may be taken into consideration.

In turn, the solution for embodiments of the invention may involve producing a calculation of the benefits 508 that the proposed structure may bring for the client. In addition, the solution may involve further drilling into the details of the benefits that the particular structure brings for the client in terms of profit and loss benefits and balance sheet benefits. The solution may also involve drilling into different graphical views. In embodiments of the invention, the answers to various questions may be received from a client and thereafter, based on those answers, the decision tree algorithms may be applied. The recommended structure 506 for the client may then be presented in a user-friendly visual format instead of the boxes, arrows and POWERPOINT® slideshows in which structures have been presented in the past.

The interactive nature of embodiments of the invention provides significant advantages. The recommended structure may be edited 510, for example, by amending and changing the structure using various input gestures on an interface that supports touch functionality, such as swipe or drag and drop actions. These actions may also be replicated with peripheral computing devices, such as a mouse. For example, in the liquidity management module 102, if the client does not want to transfer funds from one country to another, a sweep may be deleted by one of the aforementioned gestures and methods. This editing 510 of the structure may automatically update the benefit calculations 508 based, for example, on pricing details. The initially proposed structure generated by the decision tree algorithm may be further customized in such a manner to make the structure suitable for the client's needs. Such iteration of structures and discussions may occur over a period of time during which a number of structures may be proposed and discussed. In embodiments of the invention, these structures may be saved, opened, or called up for comparisons 512 with saved structures to assist in a client's decision-making process, allowing the entire experience to be truly interactive.

The foregoing discussion of the liquidity management module 102 illustrates an example of one of the many features and aspects of embodiments of the invention. Embodiments of the invention propose modules as part of the interactive solution that provide a holistic working capital story that may be used, for example, as a marketing tool that covers the end-to-end process of a financial institution's proposal of a solution to its clients. The liquidity management aspect may lead to additional global transaction services products that provide clients of the financial institution with the holistic package of solutions that allows them to improve their businesses. In addition to the liquidity management module 102, other modules for embodiments of the invention may include, for example, benchmarking 106 and payments and receivables 104, as shown in FIG. 1. Further, embodiments of the invention may automate the entire process and provide a solution for a client in real time without the exchange of numerous communications, such as e-mails, between the financial institution and the client in the iterative process that typically occurs today. Instead, embodiments of the invention may provide a tool with which the financial institution and a client may interact for only a relatively short period of time, such as a day, before coming to an agreement. Moreover, using digital signatures, the financial institution and the client may sign a contract on the spot. Thus, embodiments of the invention may automate all implementation and documentation processes that replace the current iterative process that takes such an inordinate amount of time.

As previously noted, another aspect of embodiments of the invention is a payments and receivables module 104. An objective of the payments and receivables module 104 is to show, for example, the financial institution's global transaction services presence. The countries in which the financial institution is located may be represented by a dot, which may be displayed by the application, for example, on a global map in a particular color, such as yellow. By clicking on a filter, countries in which both the financial institution and the client are located may be indicated by dots of the particular color, such as yellow, with halos of a particular color, such as white halos. In addition, on the same map, the number of countries in which both the financial institution and the client are located out of a total number of countries may be displayed. In an aspect, by drilling into a particular country, such as South Korea, all of the cities in the particular country in which the financial institution is located may be displayed. Further, by activating the filter mentioned above, all of the cities in the particular country in which the client is located may also be displayed.

In another aspect of the payments and receivables module 104, collection centers may be displayed on the global map to provide a visualization, for example, of a way in which the financial institution may be associated or allied with different collection centers such as local banks, convenience stores, or post offices, to extend the branch network for the financial institution's payments and receivables capability. In an additional aspect, drilling into a city may display a drill-down map with a city-level view of the presence of the financial institution throughout the particular city. Thus, embodiments of the invention may provide a visualization of how far the financial institution reaches into different places, such as countries and cities throughout the world. Further, embodiments of the invention enable the financial institution to show in detail on all of those levels how it may cover a client's requirements for payments and receivables by actually mapping locations where the financial institution and the client are both present.

A further aspect of the payments and receivables module 104 is visualization of capabilities. In the past, a typical response of a financial institution to a request for a proposal may have employed a two-by-two grid table to illustrate its capabilities. On such two-by-two grid tables, one axis may show all of the countries in which the financial institution is located, and the other axis may show all of the products which the financial institution may provide. Such a table is typically filled with numerous Xs and Os to represent the capabilities of the financial institution. Embodiments of the invention dispense with such tables and provide, for example, a display in a cylinder format that better summarizes the financial institution's capabilities in a more visually-friendly format. Since the presentation is in a cylinder format, it is possible to drill into different products. It is likewise possible to further drill into different countries. For example, a country may be highlighted to indicate that the financial institution provides domestic payment methods, such as cards, cross-border payments, special payments, information services, and domestic payments in the particular country. Thus, embodiments of the invention present information in a unique, user-friendly visualization format. The payments and receivables module 104, as well as all of the other modules for embodiments of the invention, provide an interactive solutioning capability similar to the liquidity management module 102. Such interactive solutioning capability may employ a similar format of asking clients a number of questions and using decision tree algorithms to come up with an ideal solution for the client in terms of payments and receivables that will allow the client to better manage its working capital.

Another interactive solutioning module for embodiments of the invention is the benchmarking module 106 which enables clients to determine, for example, the status of its treasury health compared to that of its peers and competitors in the marketplace. The benchmarking module 106 may involve displaying a number of questions in various categories related to treasury health. Based on the answers to those questions provided by the client, the benchmarking module 106 may provide an analysis and benchmark the client's treasury health versus the treasury health of the client's peers and competitors in the marketplace. In performing such analysis, the benchmarking module 106 may utilize anonymous information supplied by other clients who have responded to such questions. Such information may be stored, for example, in a database on the backend 202 from which the information may be extracted and compared to a particular client's information. The benchmarking module 106 may give the client the flexibility to choose its own peers, for example, in terms of turnover (i.e., revenue), the size of the company, or the industry. The benchmarking module 106 may also give the client the flexibility to choose for its peers to be in certain countries or geographic regions.

Based upon answers to the questions provided by the client, the benchmarking module 106 for embodiments of the invention may map a score for the client, for example, in a graph on a scale, such as a scale from zero to five. Further, the graph of the client's score may be overlaid on a graph of the collective scores of its peer, with the client's score shown in a particular color, such as green, that is different from the color in which scores of its peers are shown. As previously noted, the client's peers may be selected for particular countries or particular regions, such as all the countries in a particular geographic region. Such overlay may illustrate that the client is performing better or worse or the same as its peers in the particular region in terms of its treasury health. The benchmarking module 106 may also intelligently recommend any or all other modules for embodiments of the invention based, for example, on where a particular client may need improvement. Thus, the benchmarking module 106 may link to other global transaction services modules for embodiments of the invention that may enable the client to improve on some of the weaknesses they may have been identified during the benchmarking process.

The supply chain module 128 may be used to visualize the client's supply chain with the client's suppliers and customers, benchmark the client's key financial metrics against industry statistics, and estimate the financial benefit to the client of implementing a supplier finance program. A key challenge that banks may face in the sales process for supplier finance programs is that a bank needs to know the customer's suppliers and the size of spend with each supplier in order to produce an estimate of the financial benefit. However a client may be reluctant to share the data regarding its suppliers with the bank until it is convinced that a significant opportunity exists. It may be difficult to convince the client that a significant opportunity exists without the client's data which is needed to produce an estimate of the financial benefit. A key innovation in the supply chain module 128 is the use of supply chain analysis tools, such as Bloomberg SPLC data, to systematically produce an estimate of financial benefit without the need to approach the client for its own data. This estimate may be used to acquire the client's interest and convince it of the merit of supplier finance in order that the client may provide its own data, which can then be used to produce a more accurate benefit estimate.

The supply chain module may comprise, for example, the following main screens: i) visualization, ii) benchmarking, iii) solutions landing page, iv) preference questions, v) analysis, and vi) benefit calculation. The visualization screen may show, for example, the top ten suppliers and customers ranked by spend. Colour coding based on whether the funding cost of the supplier or customer is higher or lower than the client may be employed to provide an immediate at-a-glance insight into where opportunities for supplier finance or receivables finance exists.

The benchmarking screen may enable comparison, for example, of key financial metrics, such as cash conversion cycle (CCC), days sales outstanding (DSO), days payable outstanding (DPO), and days inventory outstanding (DIO) of the client against its peers or competitors. Each of the four parameters may be toggled on or off for clarity. An algorithm may intelligently select a number of peers, such as four peers, from a larger list of peers to be displayed on a chart. The peers which are strongest in the key financial metrics may be shown automatically so as to highlight an opportunity for improvement. An interface may be provided to allow the client to browse through other peers and replace one or more of the four displayed peers in the chart with the client's chosen alternative and to view the chart updated in real time.

The solutions landing page may introduce the bank's solutions for improving DPO and DSO for the client. The preference questions screen may receive inputs from the client in real time, the answers to which may be used to determine different solution options, such as whether a program is to be funded by the bank or by the client, and the values of variables used in the benefit calculation. The analysis screen may be used to segregate the client's suppliers into several different buckets which may differ depending on the chosen bucket dimension, such as credit rating, cost of funds, DSO, or relationship value. This feature facilitates, for example, i) selection of which suppliers are to be included on the target supplier list (i.e., those suppliers in scope for the supplier finance program and thus the benefit calculation), ii) better understanding of the supplier demographics, and iii) taking different actions later on the benefit calculation screen for different buckets of suppliers. The bucket dimension may be changed and the suppliers will be reorganized into the different buckets in real-time. A comprehensive filter may be provided to allow selection or de-selection of suppliers from the target supplier list based on certain criteria such as geography, credit rating, and the like. An intuitive drag and drop interface may be provided to enable a particularly sensitive supplier relationship to be removed from the target supplier list. For each supplier, summary details may be displayed which can be expanded into more attributes with a simple tap to expand and another tap to contract.

The benefit calculation screen may allow a different treatment to be applied against each of the different buckets of suppliers defined in the analysis screen. As an example, a terms extension of 15 days may be applied to the credit rating ‘A’ suppliers, while an extension of 30 days may be applied to suppliers rated BBB or below. The treatments include, for example, terms extension, share of suppliers' benefits, client spread, and access fee. One or more of these treatments may be available depending on the answers to the preference questions. An estimate of the financial benefits to the client may be calculated based, for example, on the treatment to be applied to each of the buckets, the supplier data, and the client preferences. An estimate of the improvement to DPO and CCC may also be calculated and displayed on a smaller area of screen which may display the original benchmarking chart with the addition of ‘New DPO’ and ‘New CCC’ columns for the client in order to show how the client may be able to catch up with, or in some cases exceed, its peers due to implementation of a supplier finance program.

An important factor in the calculation is the assumed probability of take-up of the supplier financing offer by the supplier. Algorithms may be employed to automatically estimate this probability based on comparing the offered rate against the suppliers funding cost. Further, a more aggressive or more conservative estimate may be used, depending on the client's answer to a preference question. Alternatively the client may choose to override the algorithm by entering the value manually for each bucket.

The interactive case study module 130 may allow smart search and navigation of a database of case studies saved in a database. Further, relevant case studies may be automatically selected and recommended for viewing while using other product modules, such as the liquidity management module 102, the payments and receivables module 104, and/or the supply chain module 128. Case studies have several attributes to facilitate filtering and searching including, for example, i) industry, ii) geography, and iii) solution tags. An administration website may allow configuration and tagging of case studies.

Intelligent context-aware filtering may be done based, for example, on i) the industry to which the client belongs, ii) the geography of the current context, iii) the module of interactive solutions that is currently being used, and iv) the client's answers to preference questions. For example, in the liquidity management module, if a client expresses that it is interested in global liquidity structures, a special icon may be displayed next to the client's answer to indicate that there are relevant case studies available. Once the icon is clicked, the interactive case study module may be launched with a filter intelligently set to show only those case studies that include global liquidity structures. With a single tap, the interactive case study module may be dismissed to return to the liquidity management module in its exact previous state.

The linkage of preference question answers to tags, linkage of case studies to tags, uploading of new case studies and modification of existing case studies may all be done through the administration website, such that changes are in effect immediately without any code development.

In the past, liquidity structures have typically been produced for clients manually by financial institution personnel known, for example, as solution managers. Financial institutions may offer different types of liquidity management products, such as “target balancing,” or “notional pooling” in different countries. Further, financial institutions may be faced with myriad different regulations and may have many different capabilities in different countries. In addition, the financial institution may have an extremely large matrix of different product types and different currencies in different countries. Thus, financial institutions may have a huge archive of such capabilities which may be referred to as a “capability grid.” On the other hand, financial institutions may also have a tremendously large archive of regulations. For example, in a particular country, transfer of foreign currency may be permitted, but transfer of local currency to another country may not. Likewise, conversion of local currency into foreign currency may be allowed in certain countries but not in other countries. Thus, a record of the applicable regulations may likewise form an extremely large archive, and manually validating all different scenarios, combinations, and permutations in order to arrive at a recommended structure for a client has typically been a very long and tedious process for solution managers. Further, the typically iterative process for solution managers to produce such a recommended structure may take weeks or months. Moreover, different solution managers have different ways of approaching the problem, and there has been no particular recommended or standard solution.

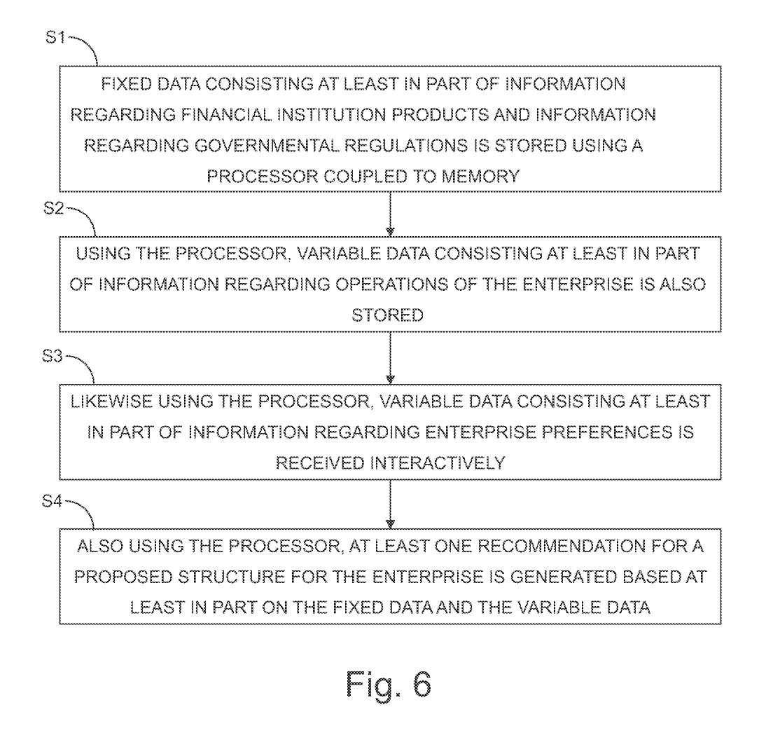

As previously noted, the process for embodiments of the invention utilizes decision tree algorithms based on a standardized, step-by-step analysis of the client's data. FIG. 6 is a flow chart that shows an example of the interactive solutioning and visualization process for embodiments of the invention. Referring to FIG. 6, at S1, using a processor coupled to memory, fixed data 214 consisting at least in part of information regarding financial institution products and information regarding governmental regulations is stored. At S2, likewise using the processor, variable data 208 consisting at least in part of information regarding operations of the enterprise is also stored. At S3, variable data is received interactively consisting at least in part of information regarding enterprise preferences 212 also using the processor. In one aspect, the variable data may comprise the client's data captured in the form of an Excel template at S3. At S4, using the processor, at least one recommendation for a proposed structure for the enterprise is generated based at least in part on the fixed data and the variable data. Thus, using the client data that may be input in such an Excel template, at S4, embodiments of the invention may employ a step-by-step validation using all combinations and permutations against the financial institution's database of regulations 222 and capabilities 216 on the backend 202.

For example, assume that a client provides a financial institution with twenty different currency accounts in ten different countries. The financial institution may input such data to compare it against a regulatory grid and a capability grid stored on the financial institution's backend database. The algorithm and validation process may be triggered, for example, by the questions to which the client provided answers. Based on how the client answers those questions, the liquidity management module 102 for embodiments of the invention may employ numerous decision trees. Also depending on how the questions are answered by the client, the liquidity management module 102 may launch, for example, one of the decision tree algorithms and present a first cut of the customized liquidity structure. As aforementioned, the recommended structure may include country specific nuances and may be further customized by interactive features of the invention.

It is to be understood that embodiments of the invention may be implemented as processes of a computer program product, each process of which is operable on one or more processors either alone on a single physical platform, such as a personal computer, or across a plurality of platforms, such as a system or network, including networks such as the Internet, an intranet, a WAN, a LAN, a cellular network, or any other suitable network. Embodiments of the invention may employ client devices that may each comprise a computer-readable medium, including but not limited to, random access memory (RAM) coupled to a processor. The processor may execute computer-executable program instructions stored in memory. Such processors may include, but are not limited to, a microprocessor, an application specific integrated circuit (ASIC), and or state machines. Such processors may comprise, or may be in communication with, media, such as computer-readable media, which stores instructions that, when executed by the processor, cause the processor to perform one or more of the steps described herein.

It is also to be understood that such computer-readable media may include, but are not limited to, electronic, optical, magnetic, RFID, or other storage or transmission device capable of providing a processor with computer-readable instructions. Other examples of suitable media include, but are not limited to, CD-ROM, DVD, magnetic disk, memory chip, ROM, RAM, ASIC, a configured processor, optical media, magnetic media, or any other suitable medium from which a computer processor can read instructions. Embodiments of the invention may employ other forms of such computer-readable media to transmit or carry instructions to a computer, including a router, private or public network, or other transmission device or channel, both wired or wireless. Such instructions may comprise code from any suitable computer programming language including, without limitation, C, C++, C#, Visual Basic, Java, Python, Perl, and JavaScript.

It is to be further understood that client devices that may be employed by embodiments of the invention may also comprise a number of external or internal devices, such as a mouse, a CD-ROM, DVD, keyboard, display, or other input or output devices. In general such client devices may be any suitable type of processor-based platform that is connected to a network and that interacts with one or more application programs and may operate on any suitable operating system. Server devices may also be coupled to the network and, similarly to client devices, such server devices may comprise a processor coupled to a computer-readable medium, such as a random access memory (RAM). Such server devices, which may be a single computer system, may also be implemented as a network of computer processors. Examples of such server devices are servers, mainframe computers, networked computers, a processor-based device, and similar types of systems and devices.

What is claimed is:

1. A method for real-time, interactive solutioning and visualization of working capital for an enterprise, comprising:
storing, using a processor coupled to memory, fixed data consisting at least in part of information regarding financial institution products and information regarding governmental regulations;
storing, using the processor, variable data consisting at least in part of information regarding operations of the enterprise;
receiving, using the processor, variable data interactively consisting at least in part of information regarding enterprise preferences; and
generating, using the processor, at least one recommendation for a proposed structure for the enterprise based at least in part on the fixed data and the variable data.

2. The method of claim 1, wherein storing the information regarding governmental regulations further comprises storing information regarding governmental regulations related to liquidity management.

3. The method of claim 2, wherein storing the information regarding governmental regulations related to liquidity management further comprises storing a regulatory grid of information regarding governmental regulations related to liquidity management in a plurality of different countries.

4. The method of claim 1, wherein storing the information regarding financial institution products further comprises storing information regarding an availability of financial institution products in a plurality of different countries in a plurality of different currencies.

5. The method of claim 4, wherein storing the information regarding the availability of financial institution products in the plurality of different countries further comprises storing a capability grid of information regarding the availability of financial institution products in the plurality of different countries in the plurality of different currencies.

6. The method of claim 1, wherein storing the information regarding operations of the enterprise further comprises storing enterprise information consisting at least in part of operating balances, legal entities, and geographic locations of the enterprise.

7. The method of claim 1, wherein storing the variable data further comprises storing anonymized information regarding operations of at least one other enterprise.

8. The method of claim 7, wherein storing the anonymized information further comprises storing anonymized information regarding operations of at least one peer of the enterprise.

9. The method of claim 1, wherein receiving the variable data interactively further comprises processing the received variable data with the stored fixed data and stored variable data using decision tree logic.

10. The method of claim 9, wherein receiving the variable data interactively further comprises receiving at least one change in the received variable data and processing the at least one received change in the received variable data with the stored fixed data and stored variable data using separate decision tree logic.

11. The method of claim 1, wherein receiving the variable data interactively further comprises receiving the variable data interactively via answers to questions displayed on a terminal.

12. The method of claim 11, wherein receiving the variable data interactively further comprises receiving the variable data interactively via answers to questions displayed on the terminal by one of a liquidity management module, a payments and receivables module, a supply chain module, and a benchmarking module.

13. The method of claim 1, wherein receiving the variable data interactively via answers to questions displayed on the terminal further comprises displaying a geographic visualization of the enterprise's global operations based at least on part on the stored variable data.

14. The method of claim 13, wherein displaying the geographic visualization of the enterprise's global operations further comprises displaying a drilled down geographic visualization of the enterprise's operations in at least one geographic region.

15. The method of claim 14, wherein displaying the geographic visualization of the enterprise's global operations in at least one geographic region further comprises displaying a drilled down geographic visualization of the enterprise's operations in at least one country.

16. The method of claim 13, wherein displaying the geographic visualization of the enterprise's global operations further comprises displaying the geographic visualization of the enterprise's global operations by a liquidity management module.

17. The method of claim 16, wherein displaying the geographic visualization of the enterprise's global operations by the liquidity management module further comprises displaying indicia of geographic locations of the enterprise's operations.

18. The method of claim 17, wherein displaying the geographic visualization of the enterprise's global operations by the liquidity management module further comprises displaying financial information in association with the indicia of geographic locations of the enterprise's operations.

19. The method of claim 1, wherein generating the at least one recommendation further comprises generating the at least one recommendation for the proposed structure for the enterprise using decision tree logic of an interactive module.

20. The method of claim 19, wherein generating the at least one recommendation further comprises generating the at least one recommendation using the decision tree logic in a step-by-step validation of the received variable data and the stored variable data in a plurality of combinations and permutations against the stored fixed data.

21. The method of claim 19, wherein generating the at least one recommendation further comprises populating at least one implementation plan and at least one legal document for the proposed structure.

22. The method of claim 21, wherein generating the at least one recommendation further comprises digitally executing the at least one legal document for the proposed structure.

23. A system for real-time, interactive solutioning and visualization of working capital for an enterprise, comprising:
a computer having a processor coupled to memory, the processor being programmed for:
storing fixed data consisting at least in part of information regarding financial institution products and information regarding governmental regulations;
storing variable data consisting at least in part of information regarding operations of the enterprise;
receiving variable data interactively consisting at least in part of information regarding enterprise preferences; and
generating at least one recommendation for a proposed structure for the enterprise based at least in part on the fixed data and the variable data.
